(19) United States
(12) Patent Application Publication
(10) Pub. No.: US 2021/0276548 A1
(43) Pub. Date: Sep. 9, 2021

(54) AN EXTENSION ADAPTIVE LANE-KEEPING CONTROL METHOD WITH VARIABLE VEHICLE SPEED

(71) Applicant: JIANGSU UNIVERSITY, Zhenjiang (CN)

(72) Inventors: Yingfeng CAI, Zhenjiang (CN); Yong ZANG, Zhenjiang (CN); Hai WANG, Zhenjiang (CN); Xiaoqiang SUN, Zhenjiang (CN); Long CHEN, Zhenjiang (CN); Jun LIANG, Zhenjiang (CN); Yicheng LI, Zhenjiang (CN); Dehua SHI, Zhenjiang (CN); Bin TANG, Zhenjiang (CN)

(21) Appl. No.: 16/626,886

(22) PCT Filed: Feb. 20, 2019
(86) PCT No.: PCT/CN2019/075504

§ 371 Date: Dec. 27, 2019

(30) Foreign Application Priority Data
Nov. 19, 2018 (CN) 201811373199.7

(51) Int. Cl. B60W 30/12; B60W 30/18; B60W 50/02

(52) U.S. Cl. CPC B60W 30/12; B60W 30/18109; B60W 2552/53; B60W 2420/42; B60W 50/0205

(57) ABSTRACT

This invention is an extension adaptive lane keeping control method with variable vehicle speed, which is composed of the following steps: S1, establishing a three-degree-of-freedom dynamic model and a preview deviation expression; S2, performing the lane line fitting equation; S3, designing the upper layer ISTE extension controller; including: S3.1, establishing the control index (ISTE) extension sets; S3.2, dividing the control index (ISTE) domain boundaries; S3.3, calculating the control index (ISTE) association function; S3.4, establishing the upper layer extension controller decision; S4, designing the lower layer speed extension controller; S5, designing the lower layer deviation tracking extension controller; including: S5.1, extracting the lower layer deviation tracking extension feature quantity and dividing domain boundaries; S5.2, designing the lower layer extension controller correlation function; S5.3, performing the lower layer measurement mode identification; S5.4, When the front wheel angle of lower layer controller outputs is calculated according to the measurement mode. This invention realizes the adaptive variation of the control coefficient of the extension controller and the boundary range of the constraint domain according to the tracking deviation precision, the speed variation, and the expert knowledge base.

### TECHNICAL FIELD

This invention belongs to the technical field of intelligent vehicle control and particularly relates to an extension lane-keeping control method with the variable vehicle speed of an intelligent vehicle.

### BACKGROUND

Intelligent vehicles have become an important carrier and meeting the requirements of safe, efficient, and intelligent transportation development have become the main targets for their development and research. Specifically, electric intelligent vehicles have a great effect on environmental pollution, energy efficiency, and traffic congestion. Among them, the lane-keeping technology of intelligent vehicles has gradually become one of the hot topics of research in the road driving process, especially curve keeping and high-speed lane-keeping performance.

To achieve self-awareness, independent decision-making, and autonomous execution to ensure safe driving, lane-keeping control of intelligent vehicles is based on the common vehicle platform, architecture computer, vision sensor, automatic control actuator, and signal communication equipment. Most common vehicles are front-wheel drive, and fire lateral control accuracy of the vehicle and the safety stability of the vehicle are ensured by adjusting the front wheel angle. The lane-keeping is based on a visual sensor, such as a camera. The lane line information is extracted through lane line detection, the position of the vehicle in the lane is acquired, and the front wheel angle to be executed at the next moment is determined based on the lane line and vehicle position information. There are two main methods of control: the pie-shooting reference system and the non-pre-attack reference system. The pre-shooting reference system mainly takes as input the road curvature at the front of the vehicle according to the lateral error or heading error between the vehicle and the desired path. To meet the control target, a feedback control system robust for the vehicle dynamic parameters is designed through various feedback control methods, such as a reference system based on a vision sensor like radar or a camera. The non-pre-attack reference system calculates a physical quantity describing the vehicle motion, such as the vehicle yaw rate, based on the desired path near the vehicle, and then designs a feedback control system for tracking. This invention is based on the pre-shooting control method. A plurality of the desired vehicle states at the front point completes the design of the extension lane-keeping control method for multi-state feedback.

### SUMMARY

From the current main research contents, the control precision and stability of intelligent vehicles lane-keeping control under large curves and high speed are hot topics of research. This invention is aimed at the control accuracy of intelligent vehicles lane-keeping in variable speeds, and an extension adaptive lane-keeping control method with variable vehicle speeds is proposed.

This invention applies the extension control method to the intelligent vehicle lane-keeping control method to ensure that the vehicle always moves within the lane range during the movement of the vehicle. The control objective of the lane-keeping is to ensure that the distance between the left lane line and the right lane line of the vehicle is equal and the heading error is zero. The upper layer extension controller of the invention adaptively adjusts the lower layer control coefficients according to the current integral square of error with time index (ISTE) of the lane-keeping. The lower layer extension controller consists of two parts, the speed extension controller and the deviation tracking extension controller, and changes the constraint domain boundary range according to the vehicle speed change, which realizes the lane-keeping control function of the intelligent vehicle with a variable speed.

The beneficial effects of this invention can be summarized as follows:
(1) Innovatively, the extension control method is applied to the lane-keeping control of intelligent vehicles during variable speed motion.
(2) The lower layer error tacking extension controller can change the control coefficient and the constraint domain boundary range adaptively according to the tracking error accuracy, speed variation, and the expert knowledge base.

### BRIEF DESCRIPTION OF THE DRAWINGS

FIG. 1 is a block diagram of the extension adaptive lane-keeping control method with variable speed;

FIG. 2 is the three-degree-of-freedom vehicle dynamic model:

FIG. 3 is the path tracking preview model;

FIG. 4 is the ISTE extension set division;

FIG. 5 is the lower layer speed extension set division;

FIG. 6 is the lower layer error tracking extension sets division.

### DETAILED DESCRIPTION

The invention is further described below with reference to the figures.

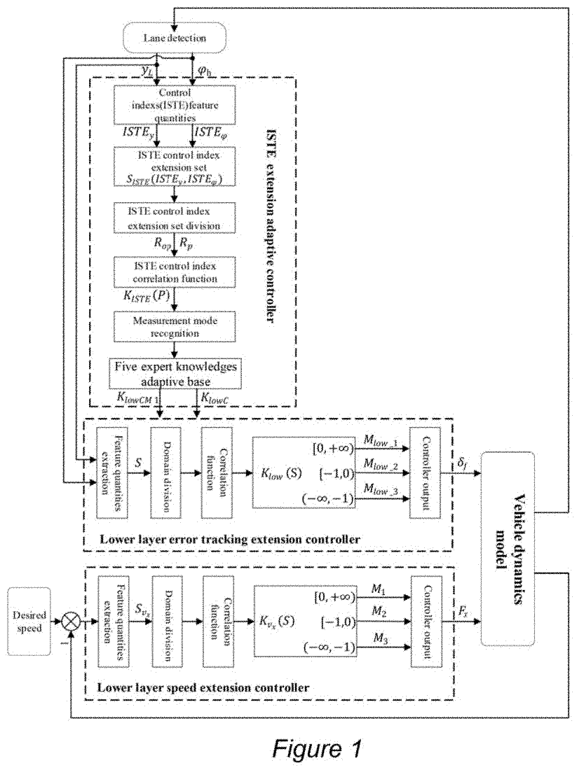

As shown in FIG. 1, the control principle and method of the invention includes the following steps:

Step 1: Establish a Three-Degree-of-Freedom Dynamic Model

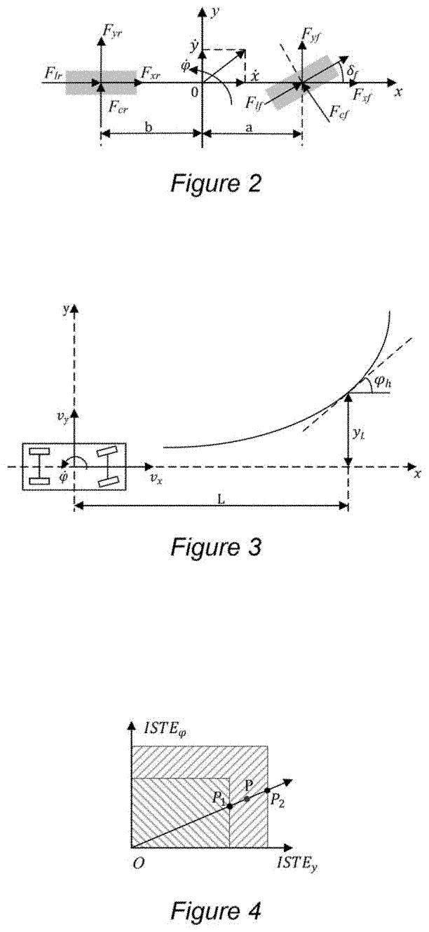

The invention adopts a three-degree-of-freedom vehicle dynamics model, including longitudinal motion, lateral motion, and yaw motion. FIG. 2 shows a schematic diagram of a vehicle three-degree-of-freedom dynamic model. According to Newton's second law theorem, the equilibrium equations along the x-axis, y-axis, and z-axis can be obtained as follows:

$$\{ \begin{matrix}m ( \ddot{x} - \dot{y} \dot{φ} ) = Σ {F}_{x} = 2 {F}_{lf} cos {δ}_{f} = 2 {F}_{cf} sin {δ}_{f} + 2 {F}_{lr} , \\ m ( \ddot{y} + \dot{x} \dot{φ} ) = Σ {F}_{y} = 2 {F}_{lf} sin {ϵ}_{f} - 2 {F}_{cf} cos {ϵ}_{f} + 2 {F}_{cr} , \\ {I}_{z} \ddot{φ} = Σ {M}_{z} = 2 ( {F}_{lf} sin {δ}_{f} + {F}_{cf} cos {δ}_{f} ) - 2 {bF}_{cr}\end{matrix} \qquad ( 1 )$$

where m is the vehicle mass; x is the longitudinal displacement; φ is the yaw angle; δ_{f} is the front wheel angle: \dot{φ} is the yaw rate: y is the lateral displacement; I_{z} is the yaw moment of inertia around Z-axis; Fₓ is the longitudinal force of vehicle; F_{y} is the lateral force of vehicle; M_{z} is the yaw moment; F_{cf} and F_{cr} is the lateral force of front tires and rear tires, respectively, related to the lateral force, corner stiffness, and slope angle of tries; F_{lf} and Fₗᵣ is the longitudinal force of front and rear tires, respectively, related to the longitudinal stiffness and slip ratio of tires; F_{xf} and Fₓᵣ is the front and rear force of x-axis, respectively; F_{y} and F_{yr} is the front and rear force of the y-axis; a is the distance of the front wheel axle from the center of gravity; and b is the distance of rear-wheel axle from center of gravity.

The preview error during the path tracking process of the vehicle includes the heading error and the lateral position error at the pre-shooting point. As shown in FIG. 3, y_{L} is the lateral position error at the pre-shooting point, φₕ is the heading error, and L is the pre-shooting distance.

According to the geometric relationship in the figure:

\dot{y}_{L}=\dot{x}φₕ−\dot{y}−\dot{φ}L (2)

\dot{φ}ₕ=\dot{x}ρ−\dot{φ} (3)

Step 2: Lane Line Fitting Calculation

Lane line fitting functions use a quadratic polynomial equation based on the road curvature ρ and the distance of the vehicle from the left line and right line D_{L}, Dᵣ, respectively. The lane line equation for the curve can be obtained as follows:

$$\{ \begin{matrix}{y}_{1} = ρ {x}^{2} + {φ}_{p} x + {D}_{L} \\ {y}_{2} = ρ {x}^{2} + {φ}_{p} x + {D}_{r} ,\end{matrix} \qquad ( 7 )$$

where ρ is the road curvature; D_{L}, Dᵣ is the distance of the vehicle from the left line and right line, respectively; φ_{ρ} is the heading angle of lane line: y₁ is left line fitting function; and y₂ is right line fitting function.

Considering that the heading error angle of the vehicle ranges from −1 rad to 1 rad, the lane line curvature setting range is set between −0.12/m and 0.12/m.

Step 3: Upper Layer ISTE Controller Design

1) Control Index (ISTE) Extension Set

The control index (ISTE) reflects the control effect, and the control target of lane-keeping ensures that the intelligent vehicle moves in the range of the lane line. In addition, it should make the lateral error y_{L} and heading error φₕ equal to zero. Therefore, in this event, the control index should consider the errors mentioned above. The calculation method of the extension control index adopts the principle of integrating the time multiplied by the square of the error. The specific expression is as follows:

ISTE_{y}=∫₀^{Ts}ty_{L}²dt

where ISTE_{y} is the control index of the lateral position error, and Tₛ is the adjustment time;

ISTE_{φ}=∫₀^{Ts}tφₕ²dt

where ISTE_{φ} is the control index of heading error, and Tₛ is the adjustment time.

The upper layer ISTE extension controller selects the control indexes ISTE_{y} and ISTE_{φ} as the feature quantities and builds the extension set S_{ISTE}(ISTE_{y}, ISTE_{φ}).

2) Control Index (ISTE) Domain Boundary

The extension control index ISTE is the integral form of the error multiplied by time, and the result varies within the range of [0, +∞). Therefore, the classical domain boundary of the control effect is expressed as follows:

$${R}_{op} = [ \begin{matrix}{ISTE}_{y} & [ 0 , {a}_{op} ] \\ {ISTE}_{φ} & [ 0 , {b}_{op} ]\end{matrix} ]$$

aₒₚ and bₒₚ are the classical domain constraint boundaries of the control index extension set, the values can be expressed as follows:

aₒₚ=∫₀^{Ts}t·r_{yop}²dt

bₒₚ=∫₀^{Ts}t·r_{φop}²dt,

where r_{yop} is the classical domain constraint range for the lateral positional error, r_{φop} is classical domain constraint range for heading error, and the two values are related to the values of the lower layer extension controller, which can adaptively adjust along with the vehicle speed.

The extension domain boundary of control index is as follows:

$${R}_{p} = [ \begin{matrix}{ISTE}_{y} & [ 0 , {a}_{p} ] \\ {ISTE}_{φ} & [ 0 , {b}_{p} ]\end{matrix} ]$$

aₚ and bₚ are the extension domain constraint boundaries of the control index extension set, the values can be expressed as follows:

aₚ=∫₀^{Ts}t·r_{yp}²dt

bₚ=∫₀^{Ts}t·r_{φp}²dt,

where r_{yp} is the classical domain constraint range for lateral positional error, r_{φp} is extension domain constraint range for heading error, and the two values are related to the values of lower layer extension controller, which can adaptively adjust with the vehicle speed.

3) Calculation of Correlation Function for the Control Index (ISTE)

In this event, to calculate the value, the correlation function of the control index (ISTE) adopts a dimensionality reduction method. FIG. 4 shows the extension set boundaries. The point P(∫₀^{Ts}ty_{L}²dt, ∫₀^{Ts}tφₕ²dt) [symbol] is the current position point in the extension set of the control indexes when the vehicle moves in the lane. The optimal state of the vehicle motion is a zero error state, that is, the origin point O (0,0). In this event, connecting the point P and the origin point, the line intersects the classical domain boundary and extension domain boundary at points P₁ and P₂, respectively. It can consider the correlation function of one-dimension extension distance based oil the points Pₓ and P₂.

The extension distance of point P and the classical domain [symbol] O, P₁ [symbol] and the extension domain [symbol] P₁, P₂ [symbol] are expressed as [symbol] [P, [symbol] O, P₁ [symbol] ] and [symbol] [P, [symbol] P₁, P₂ [symbol] ], respectively. Those values can be obtained as follows:

$$ℛ [ P , 〈 O , {P}_{1} 〉 ] = \{ \begin{matrix}- \vert OP \vert , P ∈ [ 0 , {P}_{1} / 2 ] \\ - \vert {PP}_{1} \vert , P ∈ [ {P}_{1} / 2 , {P}_{1} ] \\ \vert {PP}_{1} \vert , P ∈ [ {P}_{1} , + ∞ ]\end{matrix} \\ ℛ [ P , 〈 {P}_{1} , {P}_{2} 〉 ] = \{ \begin{matrix}\vert {PP}_{1} \vert , P ∈ [ 0 , {P}_{1} ] \\ - \vert {PP}_{1} \vert , P ∈ [ {P}_{1} , ( {P}_{1} + {P}_{2} ) / 2 ] \\ - \vert {PP}_{2} \vert , P ∈ ( ( {P}_{1} + {P}_{2} ) / 2 , {P}_{2} ] \\ \vert {PP}_{2} \vert , P ∈ ( {P}_{2} , + ∞ )\end{matrix}$$

Then, the correlation function K_{ISTE}(P) of the control index can be expressed as follows:

$${K}_{ISTE} ( P ) = \frac{ℛ [ P , 〈 {P}_{1} , {P}_{2} 〉 ]}{𝒟 [ P , 〈 {P}_{1} , {P}_{2} 〉 , 〈 O , {P}_{1} 〉 ]} ,$$

where

[symbol]

[P, [symbol] P₁,P₂ [symbol] , [symbol] O,P₁ [symbol] ]= [symbol] [P, [symbol] P₁,P₂ [symbol] ]− [symbol] [P, [symbol] O,P₁ [symbol] ]

4) Upper Layer Extension Controller Decision

An expert knowledge base is used in the upper layer extension controller decision, including five expert pieces of knowledge as follows:

a. When K_{ISTE}(P)≥0, the control satisfies the control requirements and maintains the original control coefficient.

b. When −1≤K_{ISTE}(P)<0, the control needs further improvement, and it is necessary to continue changing the control coefficient in the lower controller.

c. When K_{ISTE}(P)<−1, there is control failure.

d. When the lower characteristic state stays for a long time in the second measurement mode (i.e., the critical steady-state), it indicates that the control quantity changes little, and the control coefficient in the measurement mode should be appropriately increased to accelerate the development of the characteristic state to the steady state.

e. When the current control effect is worse than the last control effect, the coefficient in the measurement mode is returned to the previous control coefficient, and the control coefficient is appropriately reduced.

The decision result is set to:

When K_{ISTE}(P)≥0, select expert knowledge a;

When −1≤K_{ISTE}(P)<0, select three expert pieces of knowledge b, d, or e;

When K_{ISTE}(P)<−1, select expert knowledge c.

Step 4: Lower Speed Extension Controller Design

The lower layer speed extension controller feature quantity selects the deviation eᵥ_{ₓ} of the vehicle longitudinal speed vₓ and the desired longitudinal speed v_{xdis} and they constitute the speed extension controller feature set Sᵥ_{ₓ}(eᵥ_{ₓ},ėᵥ_{ₓ}) while the optimal state is S₀(0,0).

The velocity feature quantity classical domain boundary is expressed as follows:

$${R}_{{osv}_{x}} = [ \begin{matrix}{e}_{{v}_{x}} & [ - {e}_{{ν}_{x} om} , {e}_{{v}_{x} om} ] \\ {e}_{{v}_{x}}^{.} & [ - {\dot{e}}_{{v}_{x} om} , {\dot{e}}_{{v}_{x} om} ]\end{matrix} ] ,$$

where eᵥ_{ₓ}ₒₘ and ė_{V}_{ₓ}ₒₘ are the classical domain boundaries of the feature set Sᵥ_{ₓ}(eᵥ_{ₓ}, ėᵥ_{ₓ}).

The velocity feature quantity extension domain boundary is expressed as follows:

$${R}_{{sv}_{x}} = [ \begin{matrix}{e}_{{v}_{x}} & [ - {e}_{{ν}_{x} m} , {e}_{{v}_{x} m} ] \\ {e}_{{v}_{x}}^{.} & [ - {\dot{e}}_{{v}_{x} m} , {\dot{e}}_{{v}_{x} m} ]\end{matrix} ] ,$$

where eᵥ_{ₓ}ₘ and eᵥ_{ₓ}ₘ are the extension domain boundaries of the feature set Sᵥ_{ₓ}(eᵥ_{ₓ}, ėᵥ_{ₓ}).

Then, the non-domain can be defined as the remaining domains except for the classical domain and extension domain.

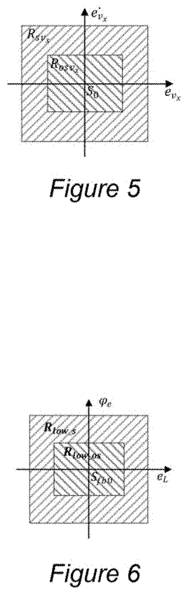

The extension set domain boundary of the speed extension controller is shown in FIG. 5.

The speed extension association function Kᵥ_{ₓ}(S) of the lower layer speed extension controller (S) is calculated as follows:

The classic domain extension distance is:

Mᵥ_{ₓ}₀=\sqrt{eᵥ_{ₓ}ₒₘ²+ėᵥ_{ₓ}ₒₘ²};

the extension domain extension distance is:

Mᵥ_{ₓ}=\sqrt{eᵥ_{ₓ}ₒₘ²+ėᵥ_{ₓ}ₒₘ²};

Moreover, the extension distance of the real-time feature state and the best state can be expressed as follows:

|Sᵥ_{ₓ}S₀|=\sqrt{eᵥ_{ₓ}²+ėᵥ_{ₓ}²};

When Sᵥ_{ₓ}(eᵥ_{ₓ},eᵥ_{ₓ})ϵRₒₛᵥ_{ₓ};

Kᵥ_{ₓ}(S)=1−|Sᵥ_{ₓ}S₀|/|Mᵥ_{ₓ}₀|;

else,

Kᵥ_{ₓ}(S)=(Mᵥ_{ₓ}₀−|Sᵥ_{ₓ}S₀|)/(Mᵥ_{ₓ}−Mᵥ_{ₓ}₀)

Therefore, the velocity feature quantity correlation function is as follows:

$${K}_{{v}_{x}} ( S ) = \{ \begin{matrix}1 - \vert {S}_{{v}_{x}} {S}_{0} \vert / \vert {M}_{{v}_{x} 0} \vert , {S}_{{v}_{x}} ( {e}_{{v}_{x}} , {\dot{e}}_{{v}_{x}} ) ∈ {R}_{{osv}_{x}} \\ ( {M}_{{v}_{x} 0} - \vert {S}_{{v}_{x}} {S}_{0} \vert ) / ( {M}_{{v}_{x}} - {M}_{{v}_{x} 0} ) , {S}_{{v}_{x}} ( {e}_{{v}_{x}} , {\dot{e}}_{{v}_{x}} ) ∉ {R}_{{osv}_{x}}\end{matrix} .$$

The output calculation of speed extension controller is:

When Kᵥ_{ₓ}(S)≥0, the real-time speed feature quantity Sᵥ_{ₓ}(eᵥ_{ₓ},ėᵥ_{ₓ}) is in the classical domain, and the state is marked as measurement inode M₁. Under this state, the speed control is easy, the control process is very stable, and it is a fully controllable state.

The output longitudinal tire force Fₓ of the controller is as follows:

Fₓ=−Kᵥeᵥ_{ₓ},

where Kᵥ is state feedback gain coefficient.

When −1≤Kᵥ_{ₓ}(S)<0, the real-time speed feature quantity Sᵥ_{ₓ}(eᵥ_{ₓ},ėᵥ_{ₓ}) is in the extension domain and the state is marked as measurement inode M₂. When the speed control difficulty is increasing, the error of actual vehicle speed and the target vehicle speed are larger, the control quantity change speed needs to be increased, and the control process is a critical steady state.
The output longitudinal force Fₓ of the controller is as follows:

Fₓ=−Kᵥeᵥ_{ₓ}+K_{vc}·Kᵥ_{ₓ}(S)·sgn(eᵥ_{ₓ}),

where K_{vc} is an additional output term gain coefficient, and sgn(eᵥ_{ₓ}) is a symbolic function that satisfies the following function:

$$sgn ( {e}_{{v}_{x}} ) = \{ \begin{matrix}1 , {e}_{{v}_{x}} > 0 \\ 0 , {e}_{{v}_{x}} = 0 \\ - 1 , {e}_{{v}_{x}} < 0\end{matrix} .$$

When Kᵥ_{ₓ}(S)<−1, the real-time speed feature quantity Sᵥ_{ₓ}(eᵥ_{ₓ},ėᵥ_{ₓ}) is in a non-domain and the state is marked as measurement mode M₃. This state is a very unstable control state. The error of actual vehicle speed and the desired vehicle speed is much larger at this time. The longitudinal force of the tire must reach a maximum value to reach the desired vehicle speed as quickly as possible, that is, Fₓ(t)=Fₓₘₐₓ.

Therefore, the output longitudinal force Fₓ of controller is as follows:

$${F}_{x} = \{ \begin{matrix}- {K}_{v} {e}_{{v}_{x}} , {K}_{{v}_{x}} ( S ) \geq 0 \\ - {K}_{v} {e}_{{v}_{x}} + {K}_{vc} \cdot {K}_{{v}_{x}} ( S ) \cdot sgn ( {e}_{{v}_{x}} ) , - 1 \leq {K}_{{v}_{x}} ( S ) < 0 \\ {F}_{xmax} , {K}_{{v}_{x}} ( S ) < - 1\end{matrix}$$

Step 5: Lower Layer Error Tracking Extension Controller Design

1) Error Tracking Extension Feature Quantities Extraction and Domain Bounding

The lower layer error tracking extension controller selects the preview lateral position error y_{L} and heading error φₕ as the extension feature quantities, which form a two-dimensional feature state set denoted as S(y_{L}, φₕ). The control target should ensure the lateral error and heading error is zero when tracking the desired path for the lateral control of intelligent vehicles. The feature quantities extension set division of the lower layer controller is shown in FIG. 6.

According to Extenics theory, the classical domain and extension domain for the feature quantities are ensured. Moreover, they can be expressed as follows:

For the classic domain,

$${R}_{low \_ os} = [ \begin{matrix}{y}_{L} & [ - {y}_{Lom} , {y}_{Lom} ] \\ {φ}_{h} & [ - {φ}_{hom} , {φ}_{hom} ]\end{matrix} ] , \qquad ( 20 )$$

where y_{Lom} and φₕₒₘ are the classical domain boundaries of the feature set S(y_{L}, φₕ).

For the extension domain,

$${R}_{low \_ s} = [ \begin{matrix}{y}_{L} & [ - {y}_{Lm} , {y}_{Lm} ] \\ {φ}_{h} & [ - {φ}_{hm} , {φ}_{hm} ]\end{matrix} ] , \qquad ( 21 )$$

where y_{Lm} and φₕₘ are the classical domain boundaries of the feature set S(y_{L}, φₕ).

Then, the non-domain can be defined as the remaining domains except for the classical domain and extension domain of the feature set S(y_{L}, φₕ).

2) Correlation Function of Lower Layer Extension Controller

For the lateral control of intelligent vehicles, the control target should ensure that the lateral error and heading error are zero when tracking the desired path. The optimal state is S_{low0}=(0,0).

In the process of vehicle motion, the real-time feature quantities are marked as S(y_{L}, φₕ), and then the extension distance of the real-time state quantities and the optimal point is as follows:

|SS_{low0}|=\sqrt{k₁y_{L}²+k₂φₕ²}, (22)

where k₁ and k₂ are the real-time state quantities and optimal state point extension weighting coefficients; the coefficients are usually 1.

The extension distance of the classic domain is as follows:

Mₑₒ=\sqrt{y_{Lom}²+φₕₒₘ²}. (23)

The extension distance of extension domain is as follows:

Mₑ=\sqrt{y_{Lm}²+φₕₘ²}. (24)

If the real-time feature state quantity S(y_{L}, φₕ) is located in the classic domain R_{low_os}, then the correlation function is as follows:

K_{low}(S)=1−|SS_{low0}|/Mₑₒ (25)

Else,

K_{low}(S)=(Mₑₒ−|SS_{low0}|)/(Mₑ−Mₑₒ). (26)

In summary, the correlation function is as follows:

$${K}_{low} ( S ) = \{ \begin{matrix}1 - \vert {SS}_{low 0} \vert / {M}_{eo} , S ∈ {R}_{low \_ os} \\ ( {M}_{eo} - \vert {SS}_{low 0} \vert ) / ( {M}_{e} - {M}_{eo} ) , S ∉ {R}_{low \_ os}\end{matrix} \qquad ( 27 )$$

3) Measure Mode Recognition of the Lower-Layer Controller

The measurement mode recognition of the system characteristic quantity S(y_{L}, φₕ) is determined according to the above the value of correlation function K_{low} (S). The measurement mode recognition rules are described below.

IF K_{low}(S)≥0, THEN the measurement mode of the real-time feature state quantity S(y_{L}, φₕ) is in the classical domain and the measurement mode state is marked as M_{low_1}. Under this state, the error tracking control is easy, and the control process is very stable, and it is a fully controllable state;

IF −1≤K_{low}(S)<0, THEN the measurement mode of the real-time feature state quantity S(y_{L}, φₕ) is in the extension domain and the measurement mode state is marked as M_{low_2}. When the error tracking control difficulty is increasing, the error of the lateral position error and the heading error are larger, the control quantity and the control quantity change speed need to be increased, and the control process is a critical steady state; ELSE, the real-time feature state quantity S(y_{L}, φₕ) is in the non-domain and the measurement mode state is marked as M_{low_3}. The error of the lane-keeping control is much larger and the vehicle even skids off the lane. The control process is an extremely unstable state.

4) Output Front-Wheel Angle of the Lower Layer Controller

When the state is in mode M_{low_1}, the state is in the stable state, and the output front-wheel steeling angle is as follows:

δ_{f}=−K_{lowCM1}S (28)

where K_{lowCM1} is the state feedback coefficient of the measurement mode M_{low_1} related to the characteristic quantity S, and K_{lowCM1}=[K_{low_c1} K_{low_c1}]^{T}, where K_{low_c1} and K_{low_c1} are the state feedback coefficients related to the feature quantity y_{L} and feature quantity φₕ. The invention adopts a pole placement method to select the state feedback coefficients and S is [y_{L} φₕ]^{T}.

When the state is in mode M_{low_2}, the state is in a critical instability state and in the controllable range. The controller can re-adjust the system to a steady-state by controlling the additional output. The output steering angle is as follows:

δ_{f}=−K_{lowCM1}{S+K_{lowC}·K_{low}(S)·[sgn(S)]}. (29)

K_{lowC} is an additional output term gain coefficient in the measurement mode M_{low_2}. To ensure that additional outputs enable the system to return to a relatively steady state, the coefficient is manually adjusted based on measurement mode M_{low_1}.

Here,

$$sgn ( S ) = \{ \begin{matrix}1 , S > 0 \\ 0 , S = 0 \\ - 1 , S < 0\end{matrix} \qquad ( 30 )$$

K_{lowC}·K_{low}(S)·[sgn(S)] is the additional output additional output term. This term combines the value of the correlation function of the lower layer controller that embodies the adjustment difficulty of the vehicle moving along the centerline of the lane during lane-keeping control. Therefore, the value of the additional output of the controller is changed in real time according to the control difficulty by changing the correlation function value.
When the state is in measurement mode M_{low_3}, it cannot be adjusted to a stable state in time because the vehicle has a large error from the centerline of the lane. To ensure the safety of the vehicle, the output steering angle of the front wheel is as follows:

δ_{f}=0 (31)

When the state is in measurement mode M_{low_3}, the error from the lane during the lane-keeping process is very large, and the lane-keeping control fails. If the vehicle wants to return to the original lane, then the front wheel corner output value is instantly large. In the case of a first vehicle speed, vehicle movement has great safety hazards under the large front wheel angle input, which should be avoided as much as possible in the control process. This situation rarely exists due to the current Chinese road planning size.

In summary, the output front wheel steering angle of lower layer deviation tracking extension controller based on characteristic quantity S is as follows:

$${δ}_{f} = \{ \begin{matrix}- {K}_{lowCM 1} S , S ( {y}_{L} , {φ}_{h} ) ∈ {M}_{low \_ 1} \\ - {K}_{lowCM 1} \{ S + {K}_{lowC} \cdot {K}_{low} ( S ) \cdot [ sgn ( S ) ] \} , S ( {y}_{L} , {φ}_{h} ) ∈ {M}_{low \_ 2} \\ 0 , S ( {y}_{L} , {φ}_{h} ) ∈ {M}_{low \_ 3}\end{matrix} . \qquad ( 32 )$$

The output of the above controller is fed back to the vehicle model, and the relevant parameters in the model are adjusted in real time so that the vehicle can adjust the lane tracking status in teal time.

The series of detailed descriptions set forth above are merely illustrative of the possible embodiments of the present invention, and they are not intended to limit the scope of the present invention. Changes are intended to be included within the scope of the invention.

1. An extension adaptive lane keeping control method with variable vehicle speed, comprising the following steps:
S1. establishing a three-degree-of-freedom dynamics model and a preview deviation equation;
S2, performing the lane line fitting calculation;
S3, designing the upper ISTE extension controller; including:
S3.1, establishing a control index ISTE extension set;
S3.2, dividing the control index of the ISTE domain boundary;
S3.3, calculating the control index ISTE correlation function;
S3.4, establishing an upper layer extension controller decision;
S4, designing a lower layer speed extension controller;
S5, designing a lower layer deviation tracking extension controller; including:
S5.1, the extraction of the lower layer deviation tracking extension feature quantity and dividing domain boundary;
S5.2, designing a lower layer extension controller correlation function;
S5.3, performing lower layer measurement mode recognition;
S5.4, the lower controller calculates the front-Wheel angle according to the measurement mode.

2. The extension adaptive lane keeping control method with variable vehicle speed according to claim 1, wherein, in Step 1 the three-degree-of-freedom dynamic model is as follows:
$$\{ \begin{matrix}m ( \ddot{x} - \dot{y} \dot{φ} ) = \sum {F}_{x} = 2 {F}_{lf} cos {δ}_{f} - 2 {F}_{cf} sin {δ}_{f} + 2 {F}_{lr} \\ m ( \ddot{y} - \dot{x} \dot{φ} ) = \sum {F}_{y} = 2 {F}_{lf} sin {δ}_{f} - 2 {F}_{cf} cos {δ}_{f} + 2 {F}_{cr} \\ {I}_{z} \ddot{φ} = \sum {M}_{z} = 2 a ( {F}_{lf} sin {δ}_{f} + {F}_{cf} cos {δ}_{f} ) - 2 {bF}_{cr}\end{matrix} ,$$
where m is the mass of the vehicle; x is the longitudinal displacement; φ is the yaw angle; δ_{f} is the front-wheel angle; y is the lateral displacement; I_{z} is the Z-axis moment of inertia; Fₓ is the total longitudinal force of the vehicle tires; F_{y} is the total lateral force of the vehicle tires; M_{z} is the total yaw moment of the vehicle; F_{cf} and F_{cr} are the lateral threes of the front and rear vehicle tires, respectively, winch are related to the lateral stiffness and the side yaw angle of the tire; F_{if} and Fᵢᵣ are before and after the vehicle, and the longitudinal force of the tire is related to the longitudinal stiffness and slip ratio of the tire; F_{xf} and Fₓᵣ are the force of the front and rear vehicle tires in the x direction; F_{xf} and F_{yr} are the force of the front and rear vehicle tires in the y direction; a is the distance from the front axle to the center of gravity; and b is the distance from rear axle to center of gravity;
the preview deviation includes a heading deviation and a lateral position deviation at the preview point, the mentioned lateral position deviation y_{L} and the heading deviation φₕ at the preview point are respectively as follows:
\dot{y}_{L}=\dot{x}φₕ−\dot{y}−\dot{φ}L
\dot{φ}ₕ=\dot{x}ρ−\dot{φ}
where L is the preview distance, and ρ is the road curvature.

3. The extension adaptive lane keeping control method with variable vehicle speed according to claim 1, wherein, the lane line fitting in Step 2 adopts a quadratic polynomial fitting, according to the road curvature value ρ and the distance between the vehicle camera and the left and right lane lines D_{L} and Dᵣ, the lane line fitting equation when the curve is obtained as follows:
$$\{ \begin{matrix}{y}_{1} = ρ {x}^{2} + {φ}_{ρ} x + {D}_{L} \\ {y}_{2}^{ } = ρ {x}^{2} + {φ}_{ρ} x + {D}_{r}\end{matrix} ,$$
where ρ is the road curvature; D_{L} and Dᵣ are the distances between the vehicle camera and the left and right lane lines, respectively; φ_{ρ} is the lane line heading angle; y₁ is the left-lane line-fitting function; and y₂ is the right-lane line-fitting function.

4. The extension adaptive lane keeping control method with variable vehicle speed according to claim 1, Wherein, when the control index ISTE extension set is established in Step 3.1, the extension control index calculation method adopts the integral of time multiplied by the square of the error, and the expression is as follows:
ISTE_{y}=∫₀^{Ts}ty_{L}²dt,
where ISTE_{y} is the control index of the lateral position error, and Tₛ is the adjustment time;
ISTE_{φ}=∫₀^{Ts}tφₕ²dt,
where ISTE_{φ} is the control index of the heading angle error, and Tₛ is the adjustment time;
the upper layer ISTE extension controller selects the control index ISTE_{y} and ISTE_{φ} as the feature quantities and establishes the extension set S_{ISTE}(ISTE_{y}, ISTE_{φ}) related to the control index;
in Step 3.2, the expression of the classic domain boundary of the control index is
$${R}_{op} = [ \begin{matrix}{ISTE}_{y} & [ 0 , {a}_{op} ] \\ {ISTE}_{φ} & [ 0 , {b}_{op} ]\end{matrix} ] ;$$
aₒₚ and bₒₚ represent the classical domain constraint range of the control index extension set, and the value can be expressed as follows:
aₒₚ=∫₀^{Ts}t·r_{yop}²dt
and
bₒₚ=∫₀^{Ts}t·r_{φop}²dt,
where r_{yop} is the classical domain constraint range of the lateral position error, and r_{φop} is the extension domain constraint range of the heading deviation:
the extension domain boundary of the control index is expressed as follows:
$${R}_{p} = [ \begin{matrix}{ISTE}_{y} & [ 0 , {a}_{p} ] \\ {ISTE}_{φ} & [ 0 , {b}_{p} ]\end{matrix} ] ;$$
aₚ and bₚ represent the extension domain constraint range of the control index extension set, and the value can be expressed as follows:
aₚ=∫₀^{Ts}t·r_{yp}²dt
and
bₚ=∫₀^{Ts}t·r_{φp}²dt,
where r_{yp} is the extension domain constraint range of the lateral position error, and r_{φp} is the extension domain constraint range of the heading deviation.

5. The extension adaptive lane keeping control method with variable vehicle speed according to claim 4, wherein, in Step 3.3 the calculation of the control index ISTE correlation function is performed by using a dimensionality reduction method, and P(∫₀^{Ts}ty_{L}²dt, ∫₀^{Ts}φₕ²dt) is the position of the current control index value point in the extension set of the control index when the vehicle is moving in the lane line: the optimal state point is that there is no deviation state, that is, the point O (0, 0), the connection origin, and the P point, and the classic domain boundary and extension domain boundary intersect at points P₁ and P₂, respectively,
then, the extension distances from point P to classical domain [symbol] O, P₁ [symbol] and extension domain [symbol] P₁, P₂ [symbol] are [symbol] [P, [symbol] O, P₁ [symbol] ] and [symbol] [P, [symbol] P₁, P₂ [symbol] ], respectively; they are:
$$ℛ [ P , 〈 O , {P}_{1} 〉 ] = \{ \begin{matrix}- \vert OP \vert , P ∈ [ 0 , {P}_{1} / 2 ] \\ - \vert {PP}_{1} \vert , P ∈ ( {P}_{1} / 2 , {P}_{1} ] \\ \vert {PP}_{1} \vert , P ∈ ( {P}_{1} , + ∞ ]\end{matrix} \\ and \\ R [ P , 〈 {P}_{1} , {P}_{2} 〉 ] = \{ \begin{matrix}\vert {PP}_{1} \vert , P ∈ [ 0 , {P}_{1} ] \\ - \vert {PP}_{1} \vert , P ∈ [ {P}_{1} , ( {P}_{1} + {P }_{2} ) / 2 ] \\ - \vert {PP}_{2} \vert , P ∈ ( ( {P}_{1} + {P}_{2} ) / 2 , {P}_{2} ] \\ \vert {PP}_{2} \vert , P ∈ ( {P}_{2} , + ∞ )\end{matrix} ;$$
the correlation function K_{ISTE}(P) of the control index is expressed as follows:
$${K}_{ISTE} ( P ) = \frac{ℛ [ P , 〈 {P}_{1} , {P}_{2} 〉 ]}{𝒟 [ P , 〈 {P}_{1} , {P}_{2} 〉 , 〈 O , {P}_{1} 〉 ]} ,$$
where [symbol] [P, [symbol] P₁, P₂ [symbol] , [symbol] O, P₁ [symbol] ]= [symbol] [P, [symbol] P₁, P₂ [symbol] ]− [symbol] [P, [symbol] O, P₁ [symbol] ].

6. The extension adaptive lane keeping control method with variable vehicle speed according to claim 5, wherein, in Step 3.4 an expert knowledge base is used in the upper layer extension controller decision, including five expert pieces of know ledge, respectively:
a. when K_{ISTE}(P)≥0, the control satisfies the control requirements and maintains the original control coefficient;
b. when −1≤K_{ISTE}(P)<0, the control needs further improvement, and it is necessary to continue to change the control coefficient in the lower controller;
c. when K_{IETE}(P)<−1, there is control failure;
d. when the lower characteristic state stays for a long time in the second measurement mode (i.e., the critical steady-state), it indicates that the control quantity changes little, and the control coefficient in the measurement mode should be appropriately increased to accelerate the development of the characteristic state to the steady-state;
e. when the current control effect is worse than the last control effect, the coefficient in the measurement mode is returned to the previous control coefficient, and the control coefficient is appropriately reduced;
the decision result is set as follows:
when K_{ISTE}(P)≥0, select expert knowledge a;
when −1≤K_{ISTE}(P)<0, select three pieces of expert knowledge b, d or e;
when K_{ISTE}(P)<−1, select expert knowledge c.

7. The extension adaptive lane keeping control method with variable vehicle speed according to claim 5, the implementation of Step 4 is composed of:
S4.1, The lower layer speed extension controller feature quantity selects the deviation eᵥ_{ₓ} of the vehicle longitudinal speed vₓ and the desired longitudinal speed v_{xdis}, and constitutes the speed-extension controller feature set Sᵥ_{ₓ}(eᵥ_{ₓ}, ėᵥ_{ₓ}), and the optimal state is S₀(0,0);
the velocity feature quantity classical domain boundary is expressed as follows:
$${R}_{o s {ν}_{x}} = [ \begin{matrix}{e}_{{v}_{x}} & [ - {e}_{{v}_{x} om} , {e}_{{v}_{x} o m} ] \\ {\dot{e}}_{{v}_{x}} & [ - {\dot{e}}_{{v}_{x} om} , {\dot{e}}_{{v}_{x} o m} ]\end{matrix} ] ;$$
the velocity feature quantity extension domain boundary is expressed as follows:
$${R}_{s {ν}_{x}} = [ \begin{matrix}{e}_{{v}_{x}} & [ - {e}_{{v}_{x} m} , {e}_{{v}_{x} m} ] \\ {\dot{e}}_{{v}_{x}} & [ - {\dot{e}}_{{v}_{x} m} , {\dot{e}}_{{v}_{x} m} ]\end{matrix} ] ;$$
S4.2, The speed extension association function Kᵥ_{ₓ}(S) of the lower layer speed extension controller (S) is calculated as follows:
the classic domain extension distance is:
Mᵥ_{ₓ}₀=\sqrt{eᵥ_{ₓ}ₒₘ²+ėᵥ_{ₓ}ₒₘ²};
the extension domain extension distance is:
Mᵥ_{ₓ}=\sqrt{eᵥ_{ₓ}ₒₘ²+ėᵥ_{ₓ}ₒₘ²};
the extension distance of real-time feature state and the best state can be expressed as:

|Sᵥ_{ₓ}S₀|=\sqrt{eᵥ_{ₓ}²+ėᵥ_{ₓ}²};
When Sᵥ_{ₓ}(eᵥ_{ₓ},eᵥ_{ₓ})ϵRₒₛᵥ_{ₓ};
Kᵥ_{ₓ}(S)=1−|Sᵥ_{ₓ}S₀|/|Mᵥ_{ₓ}₀|;
else,
Kᵥ_{ₓ}(S)=(Mᵥ_{ₓ}₀−|Sᵥ_{ₓ}S₀|)/(Mᵥ_{ₓ}−Mᵥ_{ₓ}₀)
therefore, the velocity feature quantity correlation function is as follows:
$${K}_{{v}_{x}} ( 𝒮 ) = \{ \begin{matrix}1 - \vert {𝒮}_{{v}_{x}} {𝒮}_{0} \vert / \vert {M}_{{v}_{x} 0} \vert , {𝒮}_{{v}_{x}} ( {e}_{{v}_{x}} , {\dot{e}}_{{v}_{x}} ) ∈ {R}_{{osv}_{x}} \\ ( {M}_{{v}_{x} 0} - \vert {S}_{{v}_{x}} {𝒮}_{0} \vert ) / ( {M}_{{v}_{x}} - {M}_{{v}_{x} 0} ) , {S}_{{v}_{x}} ( {e}_{{v}_{x}} , {\dot{e}}_{{v}_{x}} ) ∉ {R}_{{osv}_{x}}\end{matrix}$$
S4.3: The output calculation of speed extension controller is as follows: When Kᵥ_{ₓ}(S)≥0, the real-time speed feature quantity Sᵥ_{ₓ}(eᵥ_{ₓ}, ėᵥ_{ₓ}) is measurement mode M₁, and the state is a fully controllable state;
the output longitudinal tire force Fₓ of the controller is as follows:
Fₓ=−Kᵥeᵥ_{ₓ},
where Kᵥ is state feedback gain coefficient;
when −1≤Kᵥ_{ₓ}(S)<0, the real-time speed feature quantity Sᵥ_{ₓ}(eᵥ_{ₓ}, ėᵥ_{ₓ}) is measurement mode M₂, and the state is critical controllable state;
the output longitudinal tire force Fₓ of the controller is as follows:
Fₓ=−Kᵥeᵥ_{ₓ}+K_{vc}·Kᵥ_{ₓ}(S)·sgn(eᵥ_{ₓ}),
where K_{vc} is the additional output term gain coefficient, and sgn(eᵥ_{ₓ}) is a symbolic function that satisfies the following function:
$$sgn ( {e}_{{v}_{x}} ) = \{ \begin{matrix}1 , {e}_{{v}_{x}} > 0 \\ 0 , {e}_{{v}_{x}} = 0 \\ - 1 , {e}_{{v}_{x}} < 0\end{matrix} ;$$
when Kᵥ_{ₓ}(S)<−1, the real-time speed feature quantity Sᵥ^{x}(eᵥ^{x}, ėᵥ_{ₓ}) is measurement mode M_{3T} which is an uncontrollable state, and the controller maintain last longitudinal force, that is, Fₓ(t)=Fₓₘₐₓ;
therefore, the output longitudinal force Fₓ of the controller is:
$${F}_{x} = \{ \begin{matrix}- {K}_{v} {e}_{{v}_{x}} , {K}_{{v}_{x}} ( 𝒮 ) \geq 0 \\ - {K}_{v} {e}_{{v}_{x}} + {K}_{vc} \cdot {K}_{{v}_{x}} ( 𝒮 ) \cdot sgn ( {e}_{{ν}_{x}} ) , - 1 \leq {K}_{{v}_{x}} ( 𝒮 ) < 0 \\ {F}_{xmax} , {K}_{{v}_{x}} ( S ) < - 1\end{matrix} .$$

8. The extension adaptive lane keeping control method with variable vehicle speed according to claim 1, the preview lateral position error y_{L} and heading error φₕ in Step 5.1 are selected during the feature quantity extraction, which forms a two-dimensional feature state set, denoted as S(y_{L}, φₕ);
the mentioned domain boundary division includes:
the classic domain,
$${R}_{low \_ os} = [ \begin{matrix}{y}_{L} & [ - {y}_{Lom} , {y}_{Lom} ] \\ {φ}_{h} & [ - {φ}_{hom} , {φ}_{hom} ]\end{matrix} ] ,$$
and the extension domain,
$${R}_{low \_ s} = [ \begin{matrix}{y}_{L} & [ - {y}_{Lm} , {y}_{Lm} ] \\ {φ}_{h} & [ - {φ}_{hm} , {φ}_{hm} ]\end{matrix} ] ;$$
in Step 5.2, the method for designing the lower layer extension controller association function specifically includes the steps below;
(be real-time feature state quantity during the vehicle motion is recorded as S(y_{L}, φₕ), and then the extension distance of real-time feature state quantity and the optimal state point can be obtained as follows:

|SS_{tow0}|=\sqrt{k₁y_{L}²+k₂<φₕ²}:
the extension distance of the classic domain is as follows:
Mᵥₒ=\sqrt{y_{Lom}²+φₕₒₘ²};
the extension distance of the extension domain is as follows:
Mₑ=\sqrt{y_{Lm}²+φₕₘ²};
if the real-time feature state quantity S(y_{L}, φₕ) is located in the classic domain R_{low_os}, then the correlation function is as follows:
K_{low}(S)=1−|SS_{low0}|/Mₑₒ:
else,
K_{low}(S)=(Mₑₒ−|SS_{low0}|Mₑ−/Mₑₒ:
in summary, the correlation function is as follows:
$${K}_{low} ( 𝒮 ) = \{ \begin{matrix}1 - \vert {𝒮𝒮}_{low 0} \vert / {M}_{eo} , 𝒮 ∈ {R}_{low \_ os} \\ ( {M}_{eo} - \vert {SS}_{low 0} \vert ) / ( {M}_{e} - {M}_{eo} ) , S ∉ {R}_{low \_ os}\end{matrix} .$$

9. The extension adaptive Lane-keeping control method with variable vehicle speed according to claim 8, when the lower layer measurement mode is recognized in Step 5.3, the measurement mode recognition of system characteristic quantity S(y_{L}, φₕ) is determined by the correlation function value K_{low}(S′) the measurement mode recognition rules are as follows:
if K_{low}(S)≥0, THEN the measurement mode of real-time feature state quantity S(y_{L}, φₕ) is M_{low_1};
if −1≤K_{low}(S)<0, THEN the measurement mode of real-time feature state quantity S(y_{L}, φₕ) is M_{low_2};
else it is M_{low_3}.

10. The extension adaptive lane keeping control method with variable vehicle speed according to claim 9, in Step 5.4, the outputs the front-wheel angle of lower-layer controller includes following conditions:
when the state is in mode M_{low_1}, the state is in the stable state, and the output front-wheel steering angle is as follows:
S_{f}=−K_{lowCM1}S,
where is state feedback coefficient of measurement mode M_{low_1} related to characteristic quantity S, and K_{lowCM1}=[K_{low_c1} K_{low_c1}]^{T};
when the state is in mode M_{low_2}, then the state is in critical instability state and in the controllable range; the controller can re-adjust system to a steady-state using controller additional output; the output steering angle is as follows:
S_{f}=−K_{lowCM1}{S+K_{lowC}·K_{low}(S)·[sgn(S)]};
K_{lowC} is an additional output additional output term gain coefficient in the measurement mode M_{low_2};
where
$$sgn ( S ) = \{ \begin{matrix}1 , S > 0 \\ 0 , S = 0 \\ - 1 , S < 0\end{matrix} ;$$
K_{lowC}·K_{low}(S)·[sgn(S)] is the additional output additional output term;
when the state in measurement mode M_{low_3}, it cannot be adjusted to a stable state in time because the vehicle has a large error from the centerline of the lane; to ensure the safety of the vehicle, the output steering angle of the front wheel is as follows:
S_{f}=0;
in summary, the output front-wheel steering angle of lower layer deviation tracking extension controller based on characteristic quantity S is as follows:
$${δ}_{f} = \{ \begin{matrix}- {K}_{lowCM 1} S , 𝒮 ( {y}_{L} , {φ}_{h} ) ∈ {M}_{low \_ 1} \\ - {K}_{lowCM 1} \{ S + {K}_{lowC} \cdot {K}_{low} ( S ) \cdot [ sgn ( 𝒮 ) ] \} , 𝒮 ( {y}_{L} , {φ}_{h} ) ∈ {M}_{low \_ 2} \\ 0 , S ( {y}_{L} , {φ}_{h} ) ∈ {M}_{low \_ 3}\end{matrix}$$
